(19) United States
(12) Patent Application Publication
(10) Pub. No.: US 2012/0281961 A1
(43) Pub. Date: Nov. 8, 2012

(54) EYEWEAR FOR ACQUIRING VIDEO IMAGERY WITH ONE BUTTON TECHNOLOGY

(75) Inventor: David R. Forbes, Cedar Rapids, IA (US)

(73) Assignees: PREDATOR OUTDOOR PRODUCTS, LLC, Lancaster, PA (US); HUNTER SPECIALTIES, INC., Cedar Rapids, IA (US)

(21) Appl. No.: 13/102,631

(22) Filed: May 6, 2011

(51) Int. Cl. H04N 5/77; H04N 5/262; H04N 5/76; G02C 11/00; H04N 5/225

(52) U.S. Cl. 386/224; 351/158; 348/373; 348/207.1; 348/231.7; 348/240.99; 386/E05.003; 348/E05.024; 348/E05.055

(57) ABSTRACT

An article of eyewear includes an eyeglass frame having an integrally formed camera enclosure, an imaging sensor disposed within the camera enclosure, and a single button to control on, off, record on, and record off functions of the article of eyewear. The eyeglass frame may have a camouflage pattern. A system for recording video includes an eyeglass frame having an integrally formed camera enclosure, an imaging sensor disposed within the camera enclosure, and a wireless transceiver disposed within the eyeglass frame, and a single button to control on, off, record on, and record off functions of the article of eyewear. A method of documenting a hunt using an article of eyewear is provided.

### FIELD OF THE INVENTION

The invention relates to eyewear configured for recording video imagery. More specifically, but not exclusively, the present invention relates to eyewear configured for acquiring video imagery, the eyewear being suitable for sports such as hunting or other outdoor activities.

### BACKGROUND OF THE INVENTION

Although the present invention may be used in various applications as will be discussed herein, problems in the art will be discussed in the context of hunting. In hunting, it is at times desirable to record a hunting event. There are various reasons why one may desire a hunting event to be recorded. One reason is to provide a record of the hunting experience so that the hunter may, after the fact, relive the experience or share the experience with others. Another reason to provide a record of the hunting experience is so the hunter may self-evaluate their performance or have their performance evaluated by others so that they may improve their performance in the future.

Yet, there are difficulties in recording the hunt. Hunting does not lend itself to the use of conventional video cameras as a hunter is focused on their game and is occupied with their weapon. Nor is a hunter able to use complex user interfaces which require more than one hand or significant movement as doing so would distract the hunter from their primary purpose or even alert prey to the presence of the hunter. Although a hunter could rely on others to record their hunt, there may not be others available and having others assist may increase the likelihood of detection by game. In addition, having others record the hunt would not provide a recording from the hunter's point of view. Therefore, problems remain. What is needed are devices, methods, and system which allow a hunter to record a hunt from their own point-of-view.

### BRIEF SUMMARY

Therefore, it is a primary object, feature, or advantage of the present invention to improve over the state of the art.

It is a further object, feature, or advantage of the present invention to provide a device which has an eyewear frame with an integral camera which is mounted in such a manner that it does not impede performance of the user in hunting or other sports.

It is a still further object, feature, or advantage of the present invention to provide a device which may be used to record an event from the point-of-view of a participant in the event.

It is another object, feature, or advantage of the present invention to provide a device which is easy to use.

Yet another object, feature, or advantage of the present invention is to provide a device with an adjustable field of view.

A further object, feature, or advantage of the present invention is to provide a device that may use one button technology.

One or more of these and/or other objects, features, or advantages of the present invention will become clear from the specification and claims that follow. No single embodiment of the present invention need exhibit all of these objects, features, or advantages of the present invention.

According to one aspect of the present invention, an article of eyewear is provided. The article of eyewear includes an eyeglass frame having an integrally formed camera enclosure, and an imaging sensor disposed within the camera enclosure. The eyeglass frame may have a camouflage pattern. The eyeglass frame may include a single button to control on, off, record on, and record off functions of the article of eyewear.

According to another aspect of the present invention, a system for recording video is provided. The system includes an eyeglass frame having an integrally formed camera enclosure, an imaging sensor disposed within the camera enclosure, and a wireless transceiver disposed within the eyeglass frame. The system may include a single button to control on, off, record on, and record off functions of the system.

According to another aspect of the present invention, a method of documenting a hunt using an article of eyewear is provided. The method includes providing the article of eyewear, the article of eyewear comprising (a) an eyeglass frame having an integrally formed camera enclosure, (b) an imaging sensor disposed within the camera enclosure, (c) wherein the eyeglass frame having a camouflage pattern; and (d) wherein the eyeglass frame includes a single button to control on, off, record on, and record off functions of the article of eyewear. The method further includes activating a video recording functionality of the article of eyewear during the hunt and video recording the hunt using the article of eyewear.

### BRIEF DESCRIPTION OF THE DRAWINGS

FIG. 1 is a perspective view of one embodiment of the eyewear of the present invention.

FIG. 2 is an exploded view of the embodiment of the eyewear of the present invention shown in FIG. 1.

FIG. 3 is a bottom view of the eyewear.

FIG. 4 is a block diagram illustrating electronics of the eyewear.

FIG. 5 illustrates an image sensor.

FIG. 6 illustrates one embodiment of the eyewear where multiple imaging devices are present.

FIG. 7 illustrates another embodiment of the eyewear where a single camera is present.

FIG. 8 is a block diagram associated with another embodiment of the eyewear where the eyewear is configured for wireless communication with a remote recording device and/or a remote control.

FIG. 9 illustrates another embodiment of the present invention where the field of view of an imaging device may be adjusted.

FIG. 10 illustrates one example of a methodology for a single button controlled device.

FIG. 11 illustrates exemplary eyewear making use of the one button technology.

### DETAILED DESCRIPTION

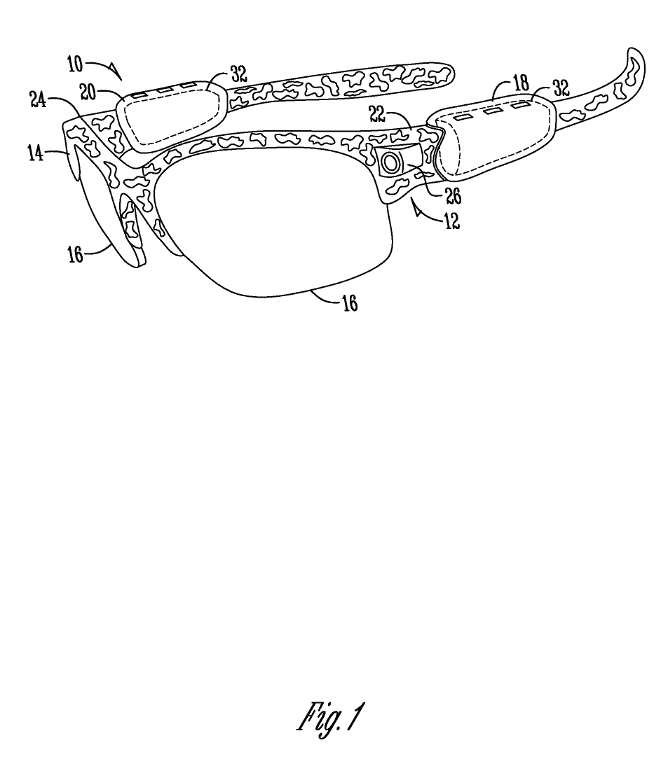

FIG. 1 illustrates a device 10. The device 10 includes an eyewear frame 14. Here, the eyewear frame 14 is patterned with camouflage as may be appropriate for certain uses of the device 10, such as by an individual who is recording a hunt. Although potentially advantageous, the eyewear frame 14 need not be patterned with camouflage and may be a solid color or otherwise patterned. The frame 14 supports a pair of lenses 16. The lenses 16 may be prescription lenses, polycarbonate shooting lenses, polarized lenses, non-polarized lenses, or other type of lenses. A pair of temples 18, 20 are pivotally connected to the frame 14 at hinges 22, 24.

The device 10 includes an image sensor 12 with an associated housing 26. The image sensor 12 allows for acquiring video imagery. As shown in FIG. 1, the image sensor 12 is positioned on the side of the eyewear frame 14. The housing 26 is located between an outer lateral edge 17 of one of the lenses 16 and an outer lateral edge 15 of the frame. Although shown on the side of the eyewear frame 14, the image sensor may be otherwise positioned. Placing the image sensor 12 on the side of the frame 14 may be advantageous over placement in the center of the frame as this placement may be less likely to interfere with the use of a scope on a weapon.

Electronics 32 may be located within one or both of the temples 18, 20 of the eyeglasses 10 or within the frame 14. The electronics 32 may include hardware for storing imagery such on removable media (such as SD cards or other memory cards).

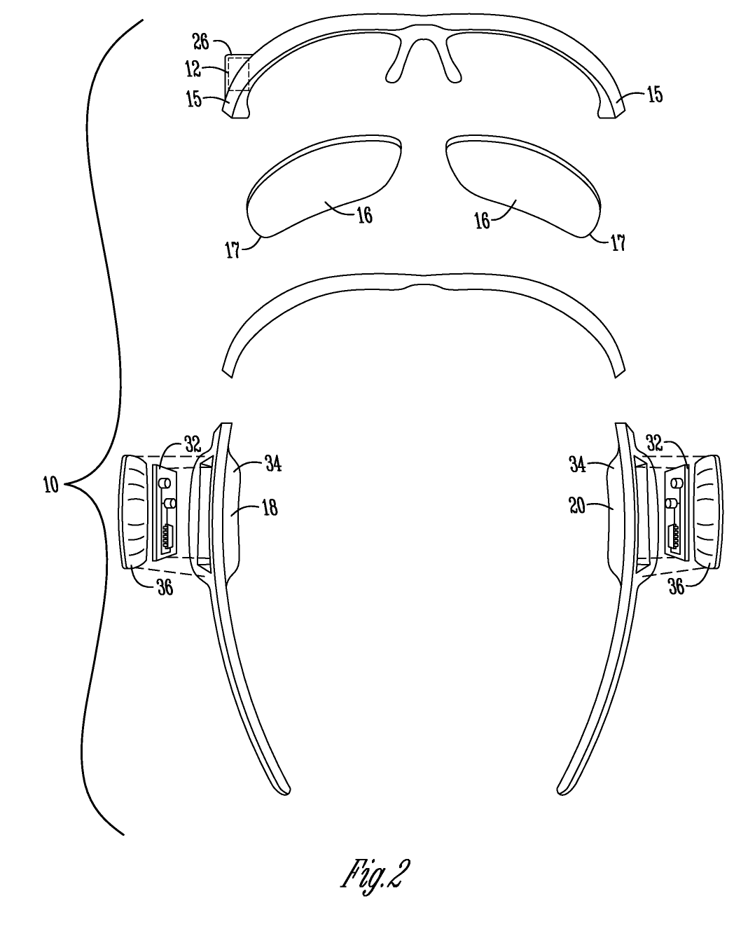

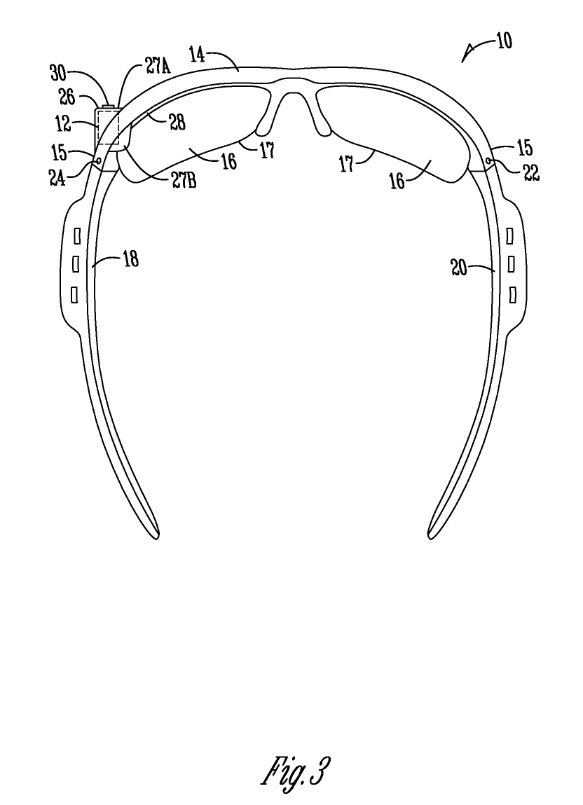

FIG. 2 provides an exploded view of the device 10 where electronics 32 are located in compartments 34 in the temples 18, 20 of the eyeglasses. Cover portions 36 are used to enclose the compartments 34. FIG. 3 illustrates the same device 10 as in FIG. 2, but in FIG. 3 the device 10 is fully assembled.

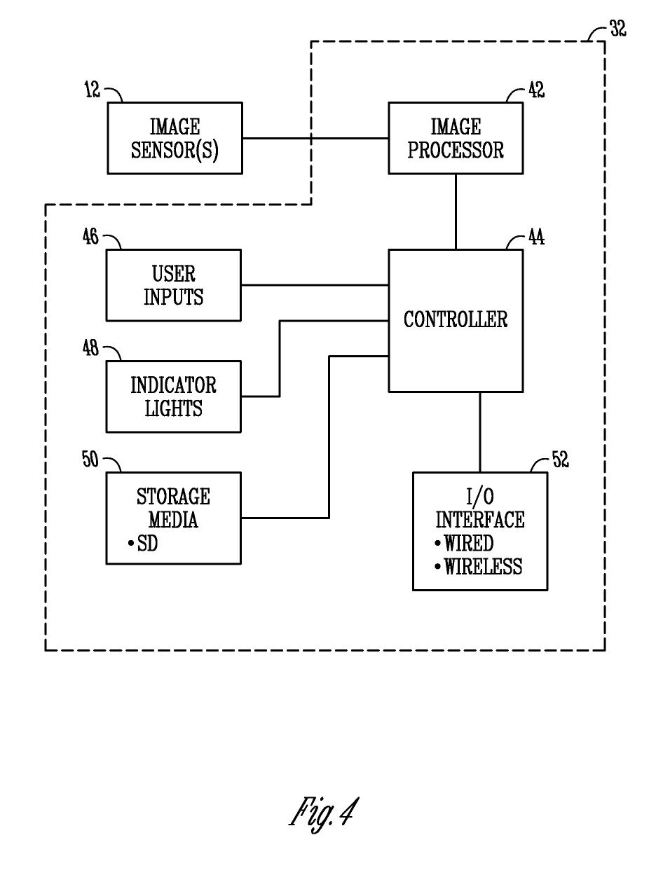

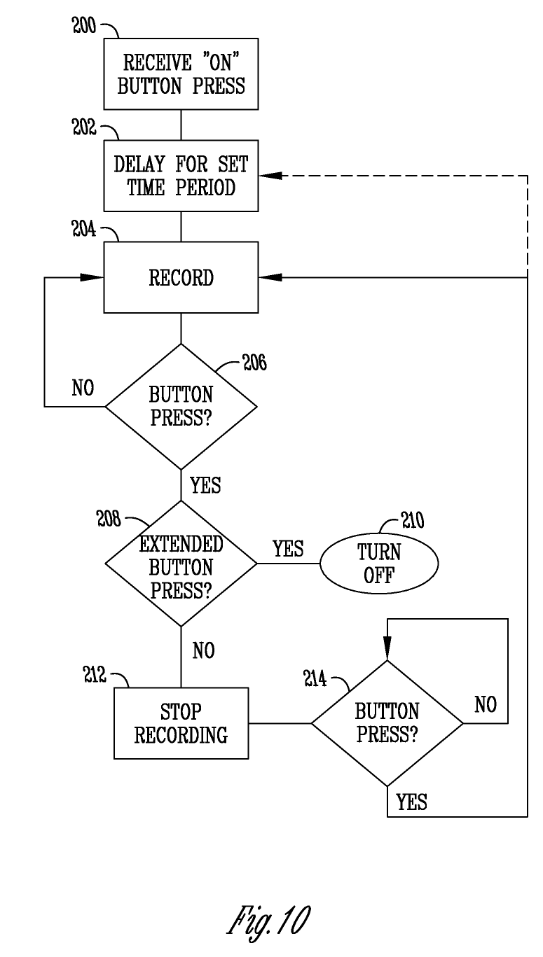

FIG. 4 is a block diagram of one embodiment of the device 10. As shown in FIG. 10, one or more image sensors 12 acquire(s) images which are communicated to an image processor 42 associated with a controller 44. The controller 44 is also operatively connected to user inputs 46 which may take the form of control buttons. The controller 44 is also operatively connected to indicator lights 48. The user inputs 46 and indicator lights 48 provide a user interface by which a user of the eyewear may interact with the eyewear in order to acquire imagery and record the imagery. An input/output interface 52 is also shown. This I/O interface is electrically connected to the controller 44. The I/O interface 52 may be a wired interface (such as a USB connector) or may be a wireless interface, such as a Bluetooth transceiver or a WiFi transceiver. Of course, other types of wired or wireless interfaces may be used. The controller 44 may also be in operative communication with storage media 50. The storage media may take different forms, examples including an SD card or micro SD card.

The user inputs 46 can take the form a single button. Where a single button is used, the same button may be used to both turn on the device and then start recording after a set delay such as 8 seconds. The button may be pressed again to stop recording. Pressing the button for an extended time period will shut off the device.

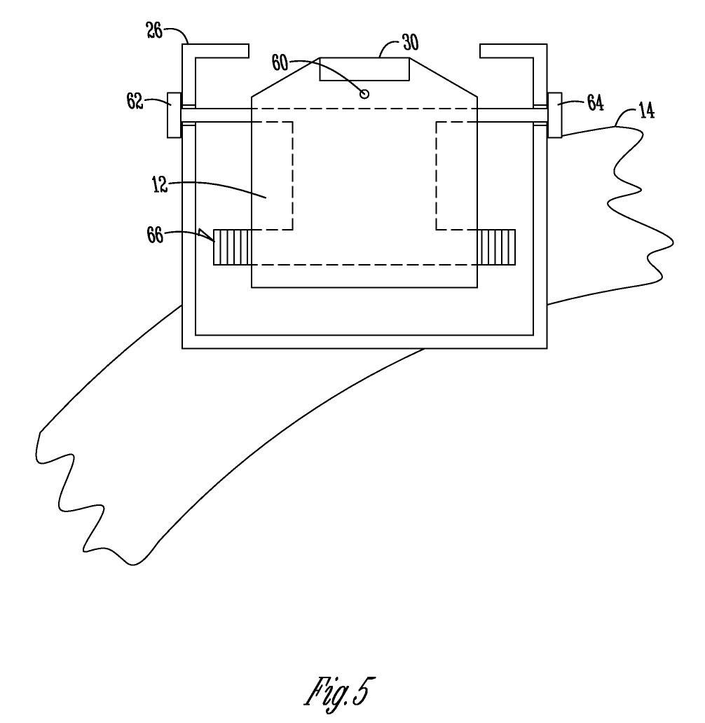

FIG. 5 illustrates one embodiment which allows adjustment of the aim and/or field of view. In order to allow adjustment of the aim and/or field of view of the lens 30, the lens 30 may be associated with known mechanical, optical, or digital means (not shown) for adjusting the aim/field of view of the lens 30. For example, the image sensor 12 and the lens 30 may be pivotally mounted within the camera enclosure 26 to allow left and right adjustment of the aim of the lens 30. As shown in FIG. 5, the image sensor 12 and the lens 30 are mounted on a pivot 60. A first adjustment button 62 and a second adjustment button 64 are located on the exterior of the camera enclosure 26. The first and second adjustment buttons are connected to a mechanical adjustment mechanism 66. The adjustment mechanism 66 is operable to change the position of the image sensor 12 and the lens 30 in response to actuation of the first and second adjustment buttons 62, 64, where each button 62, 64 corresponds to a different direction of adjustment.

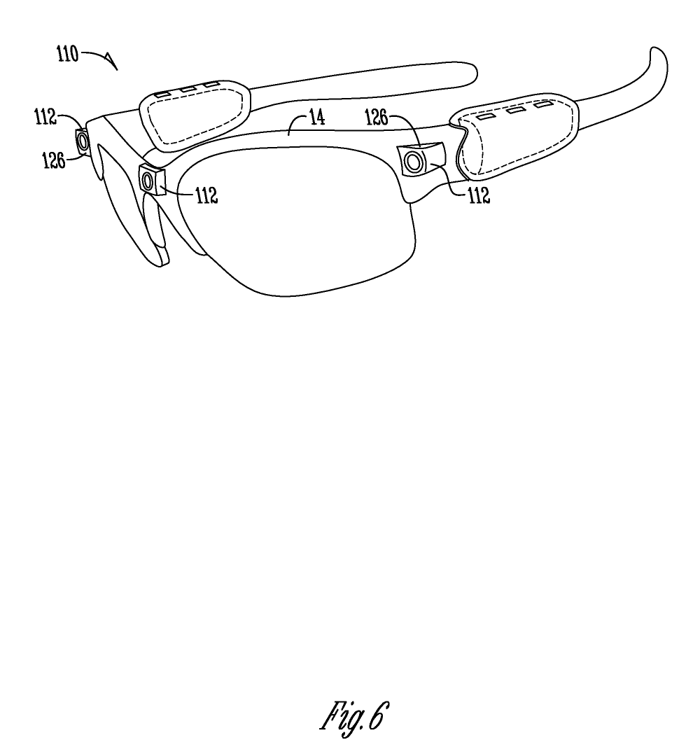

FIG. 6 illustrates another embodiment in which multiple imaging devices are present. As shown in FIG. 6, an article of eyewear 110 is provided. There are camera enclosures 126 on each side of the eyewear and three imaging devices 112 are present. The imaging devices include a centrally located imaging device on the bridge of the eyeglass frame as well as imaging devices forward of the temple on each side of the eyewear frame. The present invention allows for video to be recorded from all imaging devices simultaneously. The present invention contemplates that imagery acquired from the imaging devices may be combined in various ways. For example, a panoramic view may be created by combining the different video streams. Alternatively, a composite view may be created which is picture-in-picture, or other types of composite views may be created. Alternatively, views may be combined to create or simulate a 3-D representation.

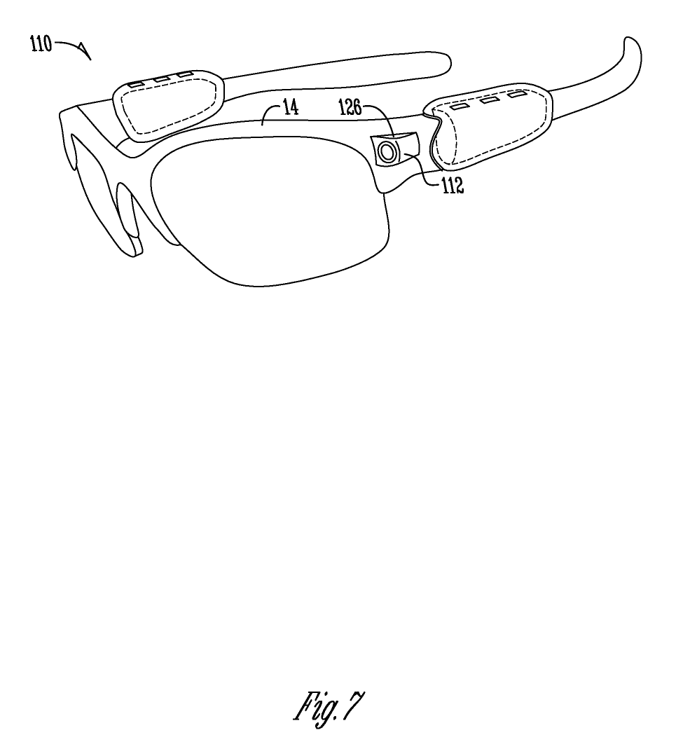

FIG. 7 illustrates another embodiment of the present invention. In FIG. 7, eyeglasses 110 are shown. The eyeglasses 10 have a single imaging device 112 within camera enclosure 126. The imaging device 112 is located forward of the temple, between the lens and the temple of the eyeglass frame 14.

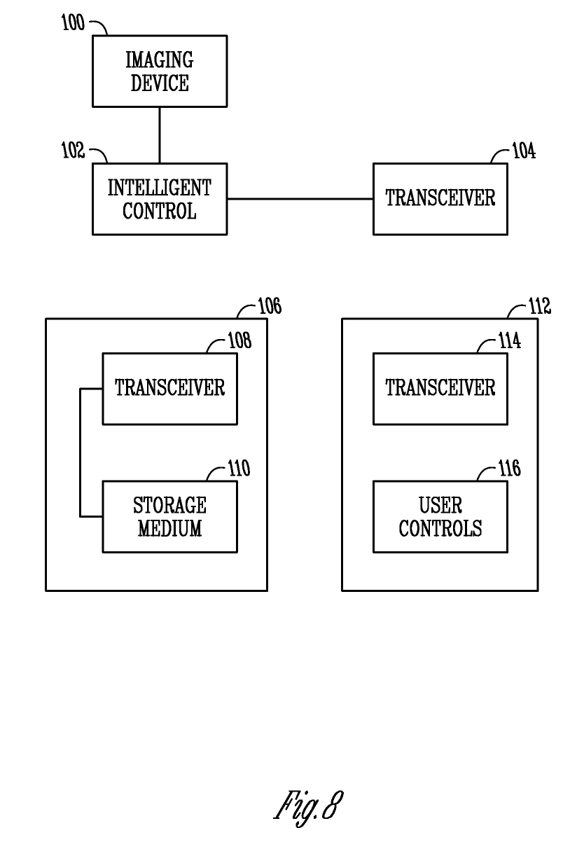

FIG. 8 is a block diagram according to one aspect of the present invention. As shown in FIG. 8, an imaging device 110 is electrically connected to an intelligent control 102. The intelligent control 102 may be a processor or other type of intelligent control. The intelligent control 102 is operatively connected to a transceiver 104. The transceiver 104 may be a Bluetooth or a Wifi transceiver or other type of transceiver. In this embodiment the eyewear wirelessly communicates such as with a remote recording device 106. The remote recording device 108 includes a transceiver 108 which may operatively communicate with the transceiver 104. The transceiver 108 is operatively connected to a storage medium 110. Thus, video imagery acquired with the imaging device 100 within an article of eyewear may be streamed to a remote device 106 for recording. The remote device 106 may be a computer, a mobile device such as a cell phone, or other type of device. Software stored on a computer readable storage medium associated with the remote device 106 may provide functionality for recording the video, combining multiple video streams, editing video or other functionality.

In addition, a remote control device 112 is shown. The remote control device 112 includes a transceiver which may be in operative communication with the transceiver 104 of the eyewear. The remote control device 112 also includes user controls 116. The remote control device 112 allows a user to turn on and off video recording functionality remotely. This may be desirably in hunting as a user would not need to reach up to their eyewear to activate recording functionality.

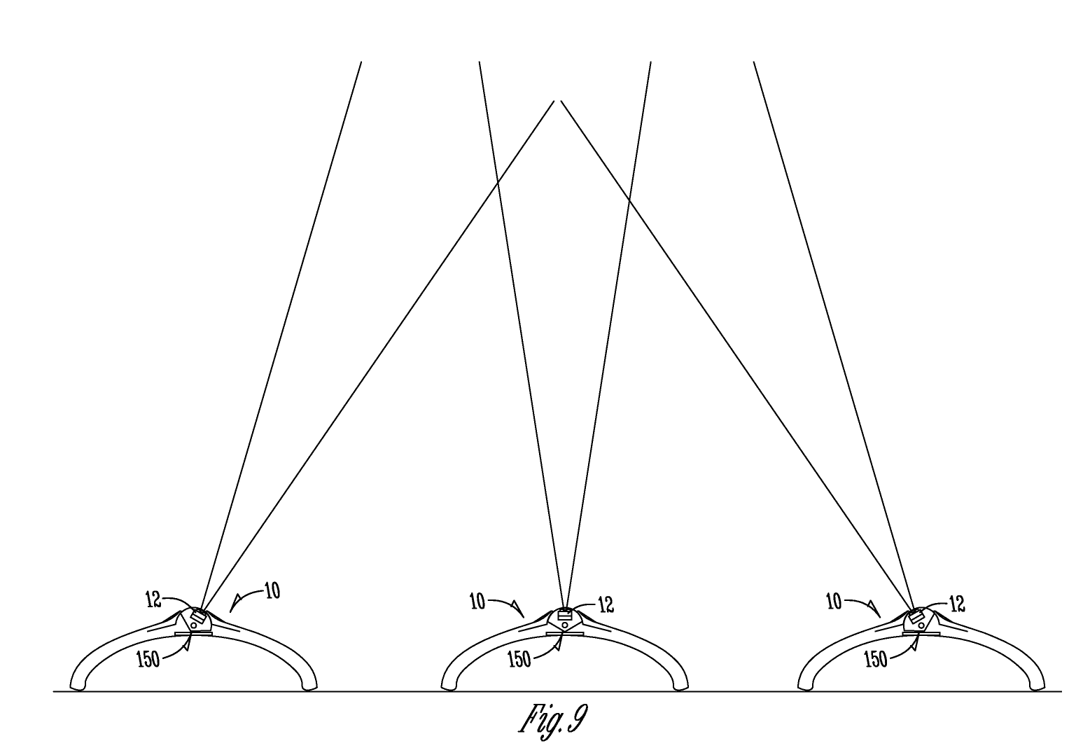

FIG. 9 illustrates another embodiment where adjustment of the angle of the field of view such as may be achieved. In this embodiment, an adjustment mechanism 150 is shown which allows the angle of the imaging device 12 to be adjusted.

FIG. 10 illustrates one embodiment of the control methodology for a single button device or “one button technology.” In step 200 a first button press is received to turn the device on. In step 202 a delay occurs for a set time period. One example of such a time period is 8 seconds. In step 204 recoding begins. In step 206 a determination is made as to whether a subsequent button press is received. If it is not, recording continues. If it is, then in step 208 a determination is made as to whether or not the button press is an extended button press such as a button press longer than 2 seconds. If the button press is an extended button press, then in step 210 the device turns off. If it is not, then in step 212 recording stops. Then in step 214 if there is a subsequent button press then recording can resume in step 204 (or alternatively a delay can take place in step 202). Although a flow chart is shown to assist in explanation, it is to be understood that numerous variations in the process and implementation may be used to achieve a desired result in a particular application.

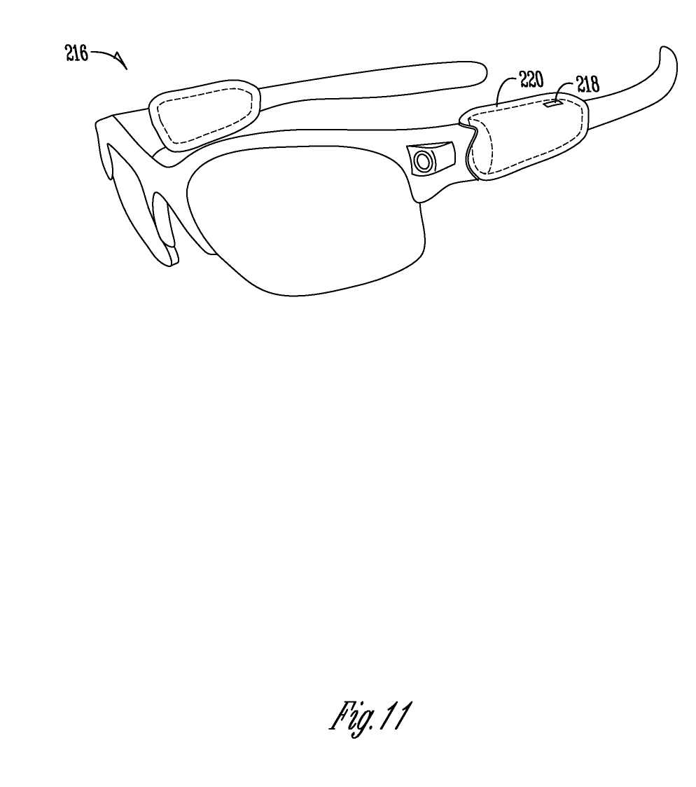

FIG. 11 shows an exemplary embodiment of the eyewear 216 using the one button technology. The single button 218 is shown disposed on the left temple 220.

The present invention contemplates that the eyewear may be used in a number of different applications. These include, without limitation, archery, shooting (including rifle, shotgun, and pistol), bow hunting, fishing, skiing, recreational sporting activities, as a teaching aid in sports or medicine, as well as animal training

Therefore, an article eyewear and related systems and methods have been described. Various different embodiments and aspects of the invention have been described. It is to be understood that the present invention contemplates numerous options, variations, and alternatives. These include variations in structure and function. It is to be further understood that different features from the different embodiments shown may be combined with features from other embodiments.

What is claimed is:

1. An article of eyewear, comprising:
an eyeglass frame having an integrally formed camera enclosure;
an imaging sensor disposed within the camera enclosure;
wherein the eyeglass frame having a camouflage pattern; and
a single button to control on, off, record on, and record off functions of the article of eyewear.

2. The article of eyewear of claim 1 wherein the eyeglass frame comprises a bridge for supporting the article of eyewear on a nose of a person.

3. The article of eyewear of claim 2 further comprising slots in the outer surface of the bridge configured for receiving lenses.

4. The article of eyewear of claim 3 further comprising a first pair of interchangeable lenses, each of the lenses having first and second opposite tabs configured for securing to the eyeglass frame.

5. The article of eyewear of claim 1 further comprising an interface connector operatively connected to the eyeglass frame.

6. The article of eyewear of claim 5 wherein the interface connector is a Universal Serial Bus (USB) interface connector.

7. The article of eyewear of claim 1 further comprising a memory card slot in the eyeglass frame for accepting a memory card.

8. The article of eyewear of claim 7 wherein the memory card slot is a secure digital (SD) memory card slot.

9. The article of eyewear of claim 1 further comprising a wireless transceiver disposed within the eyeglass frame.

10. The article of eyewear of claim 1 further comprising a user interface operatively connected to the eyeglass frame.

11. The article of eyewear of claim 10 wherein the user interface comprises a first button, a second button, a first light emitting diode (LED) and a second LED.

12. The article of eyewear of claim 1 further comprising a processor disposed within the eyeglass frame, the processor electrically connected to the imaging sensor.

13. The article of eyewear of claim 12 further comprising a memory electrically connected to processor and configured to recordings.

14. The article of eyewear of claim 13 further comprising a microphone operatively connected to the eyeglass frame and electrically connected to the processor.

15. The article of eyewear of claim 1 wherein the eyeglass frame further comprises a second integrally formed camera closure and a second imaging sensor, the second imaging sensor disposed within the second integrally formed camera closure.

16. The article of eyewear of claim 15 further comprising a user interface configured for selecting at least one of the imaging sensor and the second imaging sensor.

17. The article of eyewear of claim 1 further comprising a user interface configured for controlling a zoom function associated with the imaging sensor.

18. The article of eyewear of claim 1 wherein the imaging sensor is movably mounted on the eyeglass frame so as to allow for adjustment in angle of field of view.

19. A system for recording video, the system comprising:
an eyeglass frame having an integrally formed camera enclosure;
an imaging sensor disposed within the camera enclosure;
a wireless transceiver disposed within the eyeglass frame; and
a single button to control on, off, record on, and record off functions of the system.

20. The system of claim 19 further comprising a remote control device, the remote control device having a remote control wireless transceiver in operative communication with the wireless transceiver disposed within the eyeglass frame.

21. The system of claim 20 wherein the remote control device further comprises user controls in operative communication with the remote control wireless transceiver.

22. A method of documenting a hunt using an article of eyewear, the method comprising:
providing the article of eyewear, the article of eyewear comprising (a) an eyeglass frame having an integrally formed camera enclosure, (b) an imaging sensor disposed within the camera enclosure, (c) wherein the eyeglass frame having a camouflage pattern; and (d) a single button to control on, off, record on, and record off functions of the article of eyewear;
activating a video recording functionality of the article of eyewear during the hunt; and
video recording the hunt using the article of eyewear.

23. The method of claim 22 wherein the imaging sensor is disposed above a bridge of the eyeglass frame.

24. The method of claim 22 wherein the imaging sensor is disposed between a lens and a temple of the eyeglass frame.

25. An article of eyewear, comprising:
an eyeglass frame having an integrally formed camera enclosure;
an imaging sensor movably mounted on the camera enclosure so as to be allowable for adjustment in angle of view by pivoting the imaging sensor relative to the eyeglass frame; and
a single button on the eyeglass frame to control on, off, record on, and record off functions of the article of eyewear.
